(19) United States
(12) Patent Application Publication
(10) Pub. No.: US 2013/0161219 A1
(43) Pub. Date: Jun. 27, 2013

(54) BEVERAGE CONTAINER WITH INTEGRAL USER-MARKING APPARATUS

(71) Applicant: Sharon FRIEND, Troy, NY (US)

(72) Inventor: Sharon FRIEND, Troy, NY (US)

(21) Appl. No.: 13/333,557

(22) Filed: Dec. 21, 2011

(51) Int. Cl. B65D 85/00; B23P 11/00

(52) U.S. Cl. 206/459.1; 29/428

(57) ABSTRACT

A container for a beverage or food has a marking area having a sufficiently malleable material, such as wax, situated on the surface of the container for allowing a user to imprint and substantially maintain an identifying mark thereon. In preferred embodiments, the marking area is contained in a recess in the container, such that the identifying mark is embedded therein and is thus protected from inadvertent alterations. The wax and the marking area on the container surface may each be of at least one different color with respect to each other, such that when the identifying mark is imprinted in the marking area, the identifying mark is the same color or colors as the marking area, increasing the visibility of the identifying mark against the contrasting wax color. The user of the beverage or food container is able to easily identify and keep track of the container, even when it is among a group of similar containers, such as on the bench or sideline of a sports team or other club activity, social event, or in any other group setting, including at home within a family.

### FIELD OF THE INVENTION

This invention relates generally to beverage and food containers and, more particularly, to such a container including apparatus for allowing the user to provide a personal mark thereon for user-identification and creative expression purposes.

### BACKGROUND

Reusable and disposable beverage containers are ubiquitous in American society and throughout the world. These containers are often purchased in bulk by the case, frequently accumulate on places such as kitchen counters and picnic tables across America and are readily available for use by, for example, sports teams and other activity clubs. Typically, members of such groups use the same or similar types of beverage containers for water or sports drinks due to a limited number of brands or purchases made in bulk. A well-known problem with groups using multiple drink containers is the spread of germs, leading to illnesses, due to multiple users of the same containers. Alternatively, more circumspect users will attempt to use their own beverage containers; but these personal beverage containers are costly, require regular maintenance, and furthermore decay. In group settings, there are invariably mix-ups of beverage containers, resulting in waste of countless beverages within the mixed-up containers as well as germ transmission. Often, containers with partially used beverages will be thrown out, leading to waste of both the beverage and the container. Attempts have been made at providing means for identifying beverage containers, such as by labels and pens for marking. Unfortunately, this is often impractical or deficient and depends upon having the supplies necessary for this purpose, getting the writing instrument to perform on a non-ideal surface, and preservation of the writing such that it endures throughout the entire use. Additionally, this is time-consuming; there is limited bottle space, and users—particularly younger ones—find this solution to be dull. Other ideas have included providing integral apparatus on the beverage containers, such as adding dials to the containers which are manipulated to point to preprinted symbols, but such ideas have heretofore proven too expensive, cumbersome or impractical. Thus, the spread of germs and illnesses in group activities and at home in everyday family life continues and is pervasive, as well as the waste of beverage containers and beverage contents, to the detriment of the health of group members and the environment.

Accordingly, it is desirable to provide a beverage or food container with integral user self-marking apparatus. It is further desirable that such marking apparatus be easy and convenient to use. It is yet further desirable that such containers with the aforesaid marking apparatus be practical to manufacture. Additionally, it is desirable that such marking apparatus be perceived as fun and “cool”, in order to promote its adoption, continued use, and commercial marketability.

### BRIEF DESCRIPTION OF THE INVENTION

A container for a beverage or food has a marking area situated on the surface of the container, which marking surface comprises a sufficiently malleable material, such as a wax, for imprinting and substantially maintaining a personal identifying mark thereon for a user of the container.

In preferred embodiments, for example, a beverage or food container has a recessed area formed therein for containing the marking area, such that the identifying mark is embedded in the recessed area and is thus protected from inadvertent alterations.

Additionally, in preferred embodiments, the wax and the marking area on the container surface each comprise a different color, or multiple different colors or a color with a contrasting pattern or design such as bubbles, stars, rainbows, etc., with respect to each other, such that when the identifying mark is imprinted in the marking area, the identifying mark is the same color as the marking area. The contrasting colors between the identifying mark and the wax enables the identifying mark to be more visible and stand out on the container.

A container as described herein is not limited to any particular shape, but may comprise any shape suitable for its purpose. For example, many typical beverage containers comprise a body portion, a neck portion and a cap or lid portion, with the neck portion being narrower than the body portion. For such a container, the marking area may be situated on either the neck portion or the body portion, or even on the cap or lid portion, if desired.

A preferred method for manufacturing a container for a beverage or food having a marking area situated thereon to allow a user to imprint a personal identifying mark, comprises the steps of: providing a plastic container for containing a food or beverage; providing a marking area on the container surface; and applying and affixing wax to said marking area, such as by heating or liquefying the wax and allowing it to harden. A user may then easily and conveniently imprint a personal identifying mark into the wax marking area.

Advantageously, therefore, the user of the beverage or food container is able to easily identify and keep track of the container, even when it is among a group of similar containers, such as on the bench or sideline of a sports team, club activity, social event, or in any other group setting, including at home within a family.

### BRIEF DESCRIPTION OF THE DRAWINGS

FIG. 1 illustrates a beverage container in accordance with preferred embodiments of the present invention.

### DETAILED DESCRIPTION

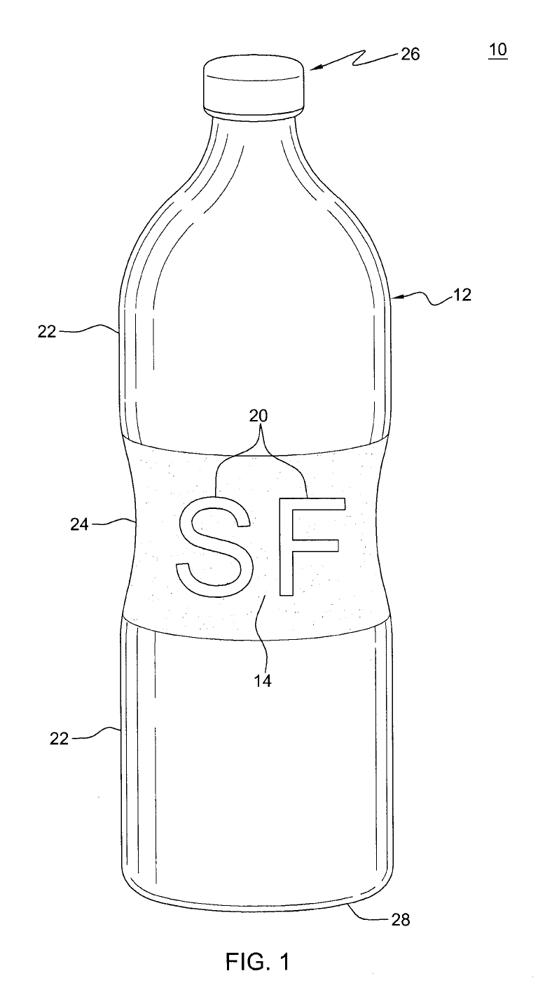

FIG. 1 illustrates an exemplary beverage container 10 in accordance with preferred embodiments of the present invention. Container 10 is illustrated and described herein specifically by way of example as a beverage container for illustrative purposes only. That is, the problems described hereinabove with respect to groups using a multiplicity of the same or similar types of containers applies most particularly to beverages, especially water. However, it is to be understood that the principles of the present invention are not limited to containers for water or other beverages, but they apply equally to containers for food as well.

Container 10 of FIG. 1 has a surface 12 with a marking area 14 situated thereon and integral therewith. Container 10 may comprise, for example, any suitable plastic useful for containing beverages, such as, for example, water or sports drinks. Marking area 14 of container 10 comprises a sufficiently malleable material, such as a wax, for imprinting and substantially maintaining a personal identifying mark thereon for a user of the container.

Advantageously, the identifying mark is designed personally for or by the user of the container. Identifying mark 20 of FIG. 1 is shown as comprising a person's initials, by way of example and illustration only. However, any other useful and suitable mark may be employed. Useful marks may comprise, for example, a letter or letters, a word, a number, a picture, or any suitable symbol or combination thereof. Advantageously, by employing easily imprintable wax in marking area 14, a user is able to effectively create a personal mark or “signature”, for easily identifying the container among multiple similar containers. Advantageously, the user is not limited to remember pre-determined symbols chosen by a manufacturer, of which many users may choose the same one.

As used herein, the term imprint refers to any means suitable for impressing a mark into wax contained in marking area 14, such as by etching, scratching, scoring, scribing or stamping, for example. Identifying mark 20 is imprinted in marking area 14 using any suitable, readily available device for imprinting into and through wax. Such a device may comprise, for example, a fingernail, a pencil, a pen, a plastic utensil, a stamp, a paper clip, a barrette, or any other available device capable of imprinting an identifying mark in marking area 14.

Beverage container 10 is illustrated in FIG. 1 as comprising a typical shape, having a body portion 22 and a narrower neck portion 24. The shape of container 10 is not, however, limited to the shape illustrated in FIG. 1 or to any other particular shape. In the illustrated embodiment of FIG. 1, marking area 14 is shown as being situated in the neck portion of container 10, but may alternatively be situated on the body portion, or even in a cap or lid portion 26, or bottom 28 of container 10, if desired. Additionally, although marking area 14 is illustrated as comprising only a part of neck portion 26, any suitable and desirable size of marking area 14 may be used. For example, marking portion 14 may extend all the way around container 10 (not shown); or there may even be more than one marking area 14 (not shown).

In alternative preferred embodiments, marking area 14 is recessed into container 10, such that identifying mark 20 is embedded in the container and is thus protected from inadvertent alterations, such as by grabbing or poking in a rough manner, or by scratching with a sharp object, or even by excessive heat from overhandling.

Additionally, in preferred embodiments, the wax and marking area 14 each comprise a different color, or multiple different colors or a color with a contrasting pattern or design such as bubbles, stars, rainbows, etc., with respect to each other, such that when the identifying mark is imprinted in the marking area, the identifying mark is the same color as the marking area. In this way, the contrasting colors between the identifying mark and the wax enable the identifying mark to be more visible and stand out on the container.

In accordance with preferred embodiments of the present invention, there is also provided a method for manufacturing a container for a beverage or food having an integral marking area for allowing a user to provide a personal identifying mark thereon. An exemplary preferred method comprises the steps of: providing a container, such as a suitable plastic, for containing a food or beverage; providing a marking area on the container surface; and applying and affixing wax to said marking area. In exemplary preferred embodiments, wax is applied to the marking area by heating the wax and allowing it to harden. A user may then easily and conveniently imprint an identifying mark into the wax marking area.

Advantageously, the user of a beverage or food container in accordance with preferred embodiments of the present invention is able to easily identify and keep track of the container, even when it is among a group of similar containers, such as on the bench or sideline of a sports team, club activity, social event, or in any other group setting, including at home within a family. In this way, the spread of germs and illnesses are avoided. In addition, waste of unused beverages and unidentified containers are also avoided, which provides a great environmental advantage as well. Advantageously, enabling the ability to add creative personalization will likely substantially increase sales of such bottles and containers by creating user affinity with these containers.

While preferred embodiments of the present invention have been shown and described herein, such embodiments are provided by way of example only. Numerous variations, changes and substitutions will occur to those skilled in the art without departing from the invention herein. Accordingly, it is in intended that the present invention be limited only by the spirit and scope of the appended claims.

1. A container for a beverage or food, comprising a container surface having a marking area situated thereon and integral therewith comprising a sufficiently malleable material for imprinting and substantially maintaining an identifying mark thereon for a user of said container.

2. The container of claim 1, wherein said malleable material comprises a wax.

3. The container of claim 1, wherein said container further comprises a recess formed therein for containing said marking area.

4. The container of claim 1, wherein said container comprises a body portion, a neck portion, a cap portion, and a bottom portion, said neck portion being narrower than said body portion, and further wherein said marking area is situated on said neck portion.

5. The container of claim 1, wherein said container comprises a body portion, a neck portion, and a bottom portion, said neck portion being narrower than said body portion, and further wherein said marking area is situated on said body portion.

6. The container of claim 1, wherein said container comprises a body portion, a neck portion, a cap portion, and a bottom portion, said neck portion being narrower than said body portion, and further wherein said marking area is situated on said cap portion.

7. The container of claim 1, wherein said container comprises a body portion, a neck portion, a cap portion, and a bottom portion, said neck portion being narrower than said body portion, and further wherein said marking area is situated on said bottom portion.

8. The container of claim 1, wherein said malleable material and said marking area each comprise at least one different color with respect to each other.

9. The container of claim 8, wherein the identifying mark is imprinted through said malleable material to said container surface, such that the identifying mark is the at least one color of said marking area.

10. The container of claim 2, comprising a plastic, and wherein said wax is affixed to said container surface by liquefying said wax and allowing said wax to harden on said container surface.

11. A method for manufacturing a container for a beverage or food having a marking area situated thereon and integral therewith for allowing a user to provide an identifying mark on said container, comprising the steps of:
providing a plastic container for containing a food or beverage, said container having a container surface;
providing a marking area on said container surface; and
applying and affixing a sufficiently malleable material for imprinting and substantially maintaining the identifying mark on said container surface in said marking area.

12. The method of claim 11, wherein said malleable material comprises a wax.

13. The method of claim 11, further comprising providing a recess in said container for containing said marking area.

14. The method of claim 11, wherein said container comprises a body portion, a neck portion, a cap portion, and a bottom portion, said neck portion being narrower than said body portion, and further wherein said marking area is situated on said neck portion.

15. The method of claim 11, wherein said container comprises a body portion, a neck portion, a cap portion, and a bottom portion, said neck portion being narrower than said body portion, and further wherein said marking area is situated on said body portion.

16. The method of claim 11, wherein said container comprises a body portion, a neck portion, a cap portion, and a bottom portion, said neck portion being narrower than said body portion, and further wherein said marking area is situated on said bottom portion.

17. The method of claim 11, wherein said container comprises a body portion, a neck portion and a cap portion, said neck portion being narrower than said body portion, and further wherein said marking area is situated on said cap portion

18. The method of claim 11, wherein said malleable material and said marking area each comprise at least one different color with respect to each other.

19. The method of claim 4, further comprising imprinting the identifying mark through said malleable material to said container surface, such that the identifying mark is the at least one color of said marking area.

20. The method of claim 12, wherein said applying and affixing step comprises liquefying said wax, applying the liquefied wax to said container surface, and allowing said wax to harden thereon.
